(19) United States
(12) Patent Application Publication
(10) Pub. No.: US 2007/0182762 A1
(43) Pub. Date: Aug. 9, 2007

(54) Real-time interactive rubber sheeting using dynamic delaunay triangulation

(76) Inventors: Xiaqing Wu, Fountain Valley, CA (US); Eugene Levin, Los Angeles, CA (US); Geoffrey T. Wade, Laguna Niguel, CA (US)

Correspondence Address: STETINA BRUNDA GARRED & BRUCKER, 75 ENTERPRISE, SUITE 250, ALISO VIEJO, CA, 92656, US

(21) Appl. No.: 11/346,766

(22) Filed: Feb. 3, 2006

(51) Int. Cl. G09G 5/00

(52) U.S. Cl. 345/647

(57) ABSTRACT

A novel, easy to use, and computational efficient rubber sheeting algorithm is designed for interactive image registration in a web-based application environment. The algorithm has two steps, including a piece-wise linear interpolation step to interactively find a suitable set of control points and displacement vectors, and a following optional global radial basis wrap step to generate smoother result using the final control point set. A dynamic Delaunay triangulation method is designed to efficiently update the decomposition of the image. Natural and intuitive wrapping result will be dynamically generated in real-time while the user interactively insert, delete or drag a control point. The number of control points is not limited, and a large number of control points can be used if necessary without compromising the performance of the algorithm. With enough control points specified using the piece-wise rubber-sheeting step, the wrapping result can be further smoothed by using the optional, click-button poly-quadric global wrapping method in the second step. The algorithm is implemented as a Java Applet and able to run as a cross-platform web-based application.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates in general to an image warping technique, and more particularly, to a real-time interactive rubber-sheet transformation technique-using dynamic Delaunay triangulation.

After the transition from the conventional paper-based mapping era to the digital mapping era, rubber sheeting has become one of the most common image warping techniques used by mapmakers to register two images of a scene based on a set of corresponding control point pairs. A classic rubber-sheeting problem in the geographic-information-system (GIS) industry is the registration of a parcel map or a street map to an aerial photo. The rubber-sheeting method generally involves a first step to resolve the spatial interpolation problem and a second step for resolving the intensity interpolation problem. In the first step, a number of corresponding control points is generated for location mapping, while in the second step, the corresponding points are used to determine the correspondence of all other points in the images, so as to determine the new pixel values for the output image.

Currently, three different approaches have been used to perform the first step, so as to resolve the spatial interpolation problem. The first approach is a bivariate mapping polynomial method which makes use of polynomial power series with unknown parameters determined by the set of control points. The polynomial method, though has been most widely used, has the disadvantages of unwanted distortion and relatively expensive computation cost, particularly when there are many control points. The second approach includes a finite element method which decomposes an image into sub-pieces and then performs a piece-wise interpolation over each of the sub-piece. Currently, various triangulation methods such as classic Greedy triangulation, minimum length triangulation, and Delaunay triangulation have been proposed for the tessellation of an image. It appears that finite-element method using triangulation has the best computational efficiency because the modification of a control point only has local effect. Therefore, it has become more and more popularly adapted in many commercial software systems. The third approach, similar to the polynomial approach, is also a global method in which displacement of an arbitrary pixel is determined by a weighted sum of radial basis parameters of each control point. Some survey has shown that the radial basis functions by far generate the best rubber-sheeting result compared to other methods. However, the computational cost is also much higher than other methods.

With regard to intensity interpolation, namely, image re-sampling, nearest neighbor, bilinear and bicubic interpolation have been commonly used.

When a target image is absent, a rubber-sheet transformation method can turn into an image morphing method, which, for example, may morph a smiling face in an image into an unhappy face by providing a specific set of control points and displacement vectors.

Recently, major internet companies such as Google and Microsoft have started to provide the web-based or on-line GIS services for general users instead of the GIS specialists. To allow general users accessing the GIS services, a user-friendly, computation efficient, and accurate rubber-sheeting algorithm is necessary. However, the conventional rubber-sheeting algorithms often require the user to provide a nice set of control points such as the street intersections to keep linear features in the process, or to provide the control points and displacement vectors as a whole set (required by methods using thin-plate splines and radial basis functions). It is hard for non-specialists to provide such a set of proper control points in advance, and even specialists need to spend a lot of time playing with several different control points configuration to get a proper result. The high computational costs of previous approaches also prevent on-line GIS service providers from implementing a real-time rubber-sheet transformation.

Hence, what is needed in the industry is a method and an apparatus for real-time intuitive rubber-sheet transformation or image warping which is computational efficient enough to be implemented as a web-based on-line application, and easy-to-use for general web users instead of GIS specialists.

### BRIEF SUMMARY

A web-based rubber-sheeting using dynamic Delaunay triangulation is provided to resolve the difficulty in choosing displacement vectors and control points occurring in the conventional rubber-sheeting techniques. When a control point is selected, added, deleted and/or moved on a screen coordinate on which an image is wrapped, the corresponding image location on an image coordinate that indicates the pixel location on the image is computed to allow the user to obtain a real-time effect on the image upon insertion, deletion, and/or movement of a control point.

The dynamic rubber-sheeting using Delaunay triangulation includes the following steps. Firstly, an original image is provided, and a dynamic Delaunay triangulation is built. The number of control points is then determined interactively through the “add” or “remove” operations of a user. When the number of the control points is equal to 1, 2 and 3, steps of setting the global translate transform, the global scale and rotate transform, and global affine transform are performed, respectively. An affine transformation for each triangle of the dynamic Delaunay triangulation is then performed to obtain the image transformed coordinates for each pixel in the triangle. The color value for each pixel is obtained by bilinear sampling, followed by a step of optional wrap of the image using global radial basis function.

In one embodiment, a flood directional search method is applied to the rubber-sheeting. When a vertex is located or selected on a screen coordinate, a referencing triangle of which the image location and the screen location of each vertex thereof are available is set up. When the vertex is contained in the referencing triangle or any neighboring triangle thereof, the image location can then be obtained based on the screen and image locations of the triangle vertices. If none of the referencing triangle and the neighboring triangles contain the vertex, a null searching result is output, and another referencing triangle may be set until the triangle containing the vertex is found.

When a control point is added in the screen coordinate, similar to the flood directional search method, the triangle containing the control point is found. The image location of the control point is found, and the triangle containing this added control point is partitioned into three new image triangles. Each of the new image triangles is checked and if any new image triangles have a nonempty circum circle, an edge flip process is performed, and the new image triangle and a neighboring triangle sharing the common edge therewith are converted into two new image Delaunay triangles. However, to avoid generation any flipped triangle in the screen coordinate, after the edge flip process is performed, a helping control point is pushed to a stack to be inserted later in the triangulation.

When a control point is deleted from an image, again, the triangle containing the detected control point is located, and the local region affected by deletion of the control point is removed. The image vertex representing the deleted control point on the image coordinated is deleted. The triangulation is then updated to result in a plurality of locally updated triangles. Again, to avoid generation of flipped triangle in the screen coordinate, a step of recursive visibility adjustment is performed before the affine transformation for each updated triangle is updated.

When a control point is moved on the screen coordinated, screen areas of all the triangles associated with the control point were checked. If all the associated triangles have positive areas, a step of updating screen location of the control point is performed, followed by a step of updating affine transformation for all the associated triangles. If any of the associated triangles has a negative area, the moving process of the control point is terminated.

Although the rubber sheeting method is focused on image to image registration and image wrapping, it can also be used to align a vector map with a raster image with a simple modification in the mapping procedure. For vector-to-raster alignment, vertex-to-pixel mapping is applied in each triangle affine transformation instead of pixel-to-pixel mapping, and the aligned vector map can be generated using all the adjusted vertices.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows the Delaunay triangulation of a point set and its dual graph;

FIG. 2 illustrates the process flow of the real-time rubber-sheet transformation;

FIG. 3 illustrates a triangle data structure;

FIG. 4 shows the control point structure and the dynamic triangulation structure based thereon;

FIGS. 5-7 show the basic functionalities of the dynamic Delaunay triangulation method as shown in FIG. 2;

FIG. 8 shows a directional flood method used to locate a vertex in the dynamic Delaunay triangulation method;

FIGS. 9A to 9D show the flipped triangles when a control point is inserted;

FIGS. 10A and 10B shows the addition of helping points;

FIG. 11 illustrates the detailed procedure for inserting a control point; and

FIGS. 12A and 12B show the local property by inserting and removing a control point.

### DETAILED DESCRIPTION

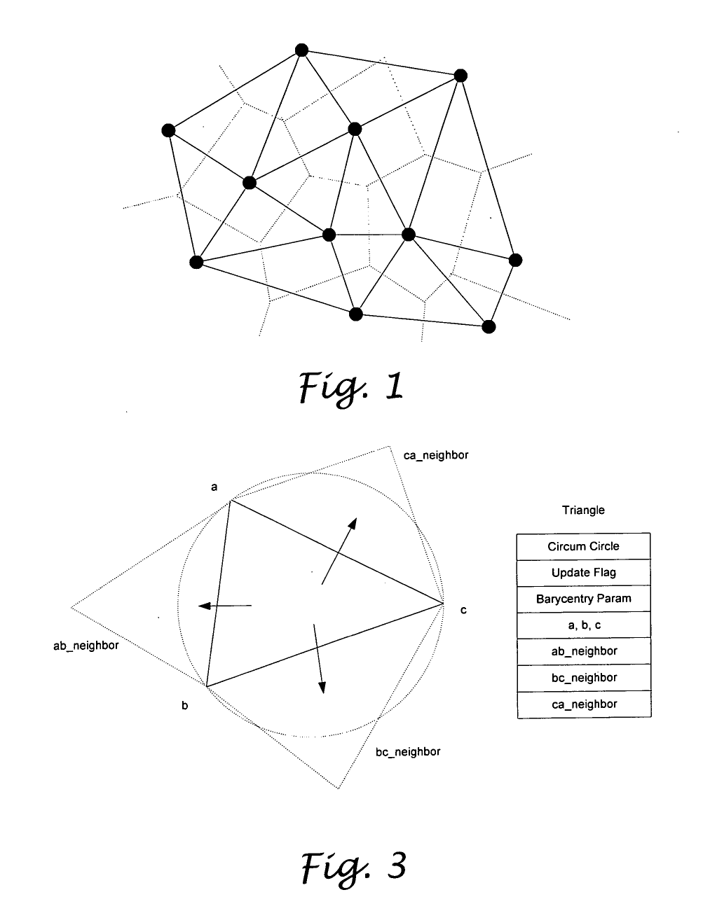

As mentioned above, the first step for the rubber-sheet transformation method is to select a number of corresponding control points for location mapping. In this embodiment, Delaunay triangulation that has been the most popular triangulation because of its speed of construction and its nice structural properties is used to decompose an image to be warped, so as to generate the corresponding control points. The Delaunay triangulation of a point set S in R² is the straight-line dual of the Voronoi diagram of S as shown in FIG. 1. More specifically, for a given point set S, its Delaunay triangulation DT(S) is a triangulation of S such that no other point of S will exists within the circumcircle of every triangle. The edges of a Delaunay triangulation are called Delaunay edges. The existence of a Delaunay edge is guaranteed between a point and its closest neighbor.

Thus defined, the application of Delaunay triangulation to tessellation provides the advantages of maximizing the minimum angle, localizing the update effect, pairing nearby points, efficient and unique. Maximization of the minimum angle is very important to rubber sheeting because triangles with small angle often lead to over-magnification and may generate artifacts. When a point is inserted, deleted or moved in Delaunay triangulation, the changes will be limited to the updated location without causing a ripping effect throughout the triangulation. According to the above definition, a control point will always be linked by a Delaunay edge to its closest control point in Delaunay triangulation; and therefore, any point on such Delaunay edge is closer to one of these two control points than any other control points. Such definition renders Delaunay triangulation fast to construct and update and requiring only simple and fast algorithm. In addition, for a given set of control points, its Delaunay triangulation is unique regardless of the order in which the control points are specified.

FIG. 2 shows a flow chart of a tessellation method, namely, dynamic Delaunay triangulation method, operative to interactively and smoothly rubber sheeting an image in real time as a web-based application. As shown, when an original image to be wrapped is displayed in step 20, a step of building dynamic Delaunay triangulation based on all the current control points is initiated in step 21. As it will be further discussed later in the specification, the dynamic Delaunay triangulation is initiated by setting a referencing triangle that has three vertices located at infinity on the image. Once a control point is selected and set as a vertex, the coordinate of such control point on the image can be computed with reference to the vertices of the referencing triangle, and the initial referencing triangle is then partitioned into smaller triangles. Depending on the number of the current control points determined in step 22, different transformation will be performed. When more than three control points are found in step 22, an affine transformation for each triangle is generated in step 24. When less than three control points are found in step 23, three different steps will be performed according to the exact number of the control points. When there is only one control point, a global translate transform is set up in step 23A, and an affine transformation is generated based on the setup global translate transform in step 24. When two control points are found in step 22, both global scale and rotation transformation are set up in step 23B. When there are exactly three control points, a global affine transformation is set up in step 23C. Both the steps 23B and 23C are also followed by generation of affine transformation for each triangle in step 24. When an affine transformation is generated for each of triangle, the image coordinates for each pixel in each triangle is provided in step 25, and color value for each pixel can be provided by bilinear sampling in step 26, so as to obtain the triangular sub-image(s). If any control point is added, deleted or moved after updating triangular sub-image in step 26, the process may go back to step 22 for modification. In addition, the image wrapping can be smoothed using global reversed radial basis function in steps 28 and 29.

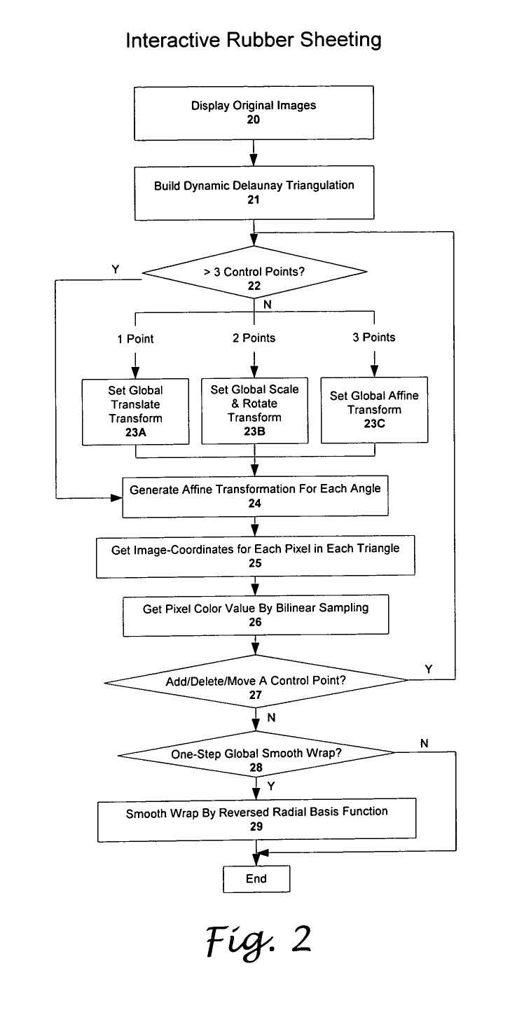

The fast and interactive rubber-sheeting functionality is realized by the support of the dynamic Delaunay triangulation method, for which a set of specific data structures is designed and developed. In the dynamic Delaunay triangulation method, the triangle is used as the fundamental data structure instead of the edge for being able to represent the Delaunay triangulation and its dual, that is, the Voronoi diagram at the same time. Another advantage of choosing the triangle is that the triangle is also the basic interpolation unit of the image transformation. As shown in FIG. 3, each triangle is composed of 3 vertices a, b, and c in counterclockwise order and three pointers ab neighbor, bc neighbor, and ac neighbor to the neighbor triangles. Since each triangle defines a unique affine transformation which will be used often in image transformation, the Barycentric coefficients of each triangle in the data structure are kept to increase the speed of the affine transformation. A Boolean update flag is also presented for the purpose of searching, updating and drawing of the graph. The data structure for each triangle vertex or control point is shown in FIG. 4, which includes two sets of coordinates, that is, an image coordinate representing its location on the image and a coordinate representing the target location to which the image to be moved. During interactive rubber-sheeting, screen coordinates of a control point may be changed, however, the corresponding image coordinate of the control point will remain the same. The track of the order that a control point is inserted is kept and saved in an “age” field, which is important for the interactive insert and delete operations in rubber-sheeting as discussed in details as follows.

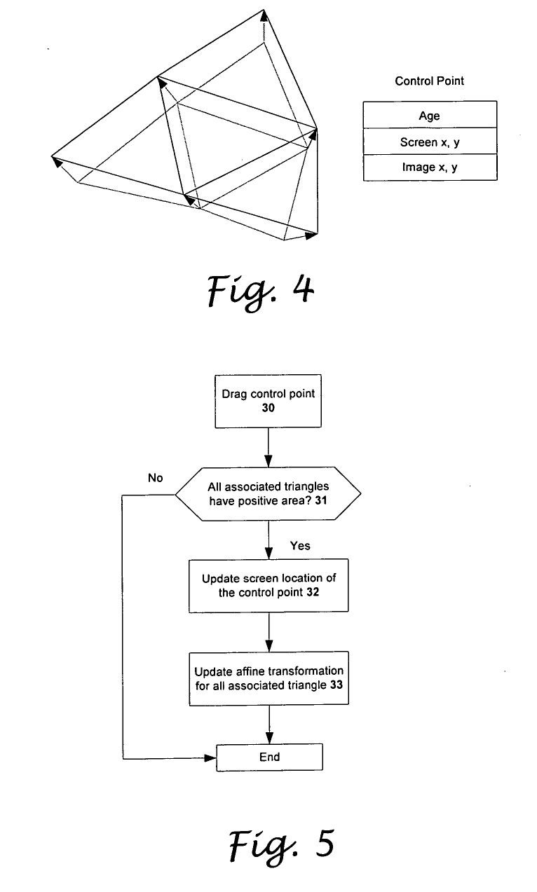

The dynamic triangulation structure is a collection of triangles based on the control-point structure and implemented as a subclass of the triangle classes with special functions to locate vertex, insert vertex and delete vertex. Initially, the dynamic triangulation structure is constructed as a super large triangle with three virtual vertices at infinity, such that any new points to be inserted will be inside this initial triangle. Because of the dual coordinates of each control point, the dynamic triangulation structure actually contains two homomorphic triangulations, including the triangulation with all the image coordinates of control points or image triangulation and the triangulation with all the screen coordinates, namely, the screen triangulation as shown in FIG. 4. The image triangulation will always be a Delaunay triangulation of all the image coordinates. The methods of locating, inserting and deleting vertex of triangulations are illustrated in FIGS. 5, 6 and 7, respectively.

As shown in FIG. 5, when an image to be warped is display on a screen, the user may use an input device such as a mouse to drag an existing control point to a desired location on the screen in step 30. Once the control point is selected, a step of determining whether all the triangles associated with the control point have positive area is performed in step 31. When all the associated triangles have positive areas, the screen location of the control point is determined in step 32, and the affine transformations for all the associated triangles are updated in step 33. If the areas of the associated triangles are not all positive, the process is terminated and so the user will not over-drag the control point to generate a flipped triangle. If the areas of all the triangles are found positive in step 31, the screen location of the control points are updated to the new screen location of the mouse that the user has dragged in step 32, and affine transformation for all these triangles is updated in step 33.

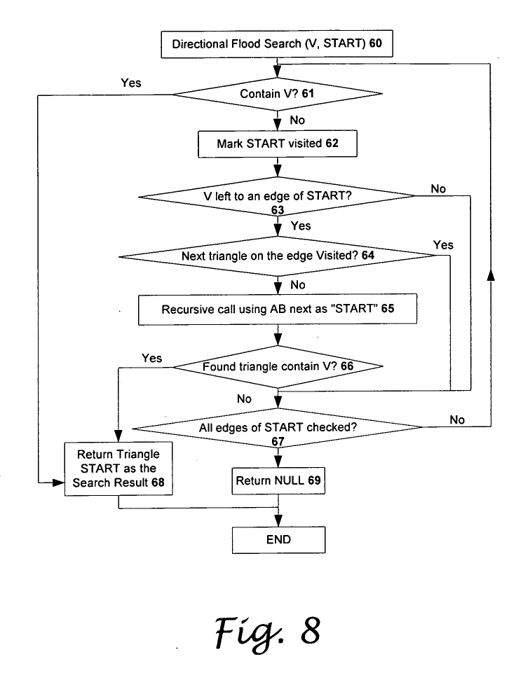

FIG. 8 illustrates an exemplary method, namely, a directional flood method, developed to determine whether a control point as selected on the screen is a vertex for a specific triangle in the triangulation. Traditionally, point location problem in Delaunay triangulation can be solved using triangle walk method with a linear time complexity. In this embodiment, the triangulation associated with the intermediate image is the triangulation of the on-screen coordinates of the control points, which is not a Delaunay triangulation and will not guarantee the triangle-walk will converge and stop. Directional flood method is able to solve this problem in a simple and efficient way. The directional flood method is initiated by setting a referencing triangle “START” and a vertex V in step 60. The referencing triangle “START” is often set as the system active triangle that the user last modified or visited and has three vertices a, b, c in both the image coordinate and the screen coordinate. In step 61, a step of determining whether V is contained by the referencing triangle “START” is performed. If the vertex V is contained by the referencing triangle “START”, the process returns to step 60 for a new vertex V and the previously or newly set referencing triangle “START”. If the vertex V is not contained by the referencing triangle “START”, the referencing triangle “START” is marked as being “visited” or “checked” in step 62. Therefore, the same referencing triangles will not be revisited. The location of the vertex V relative to an edge of the referencing triangle “START” is then determined in step 63. As the referencing triangle “START” is preferably counterclockwise set, if the control point V is located at the left side of the edge, it indicates that the vertex V is outside of the referencing triangle “START”, and the neighboring triangle on this edge has a bigger possibility to contain V than other neighbor triangles, and the algorithm will continue to search in this direction recursively in steps 64, 65 and 66. If the vertex V is found at the other side of the edge in step 63, the neighboring triangle on this edge is not likely to contain V. The relative locations of the vertex V to other edges of the reference triangle “START” are then examined in step 67, so as to find another direction to continue the search. If no triangle is found in the recursive procedure and all edges of the reference triangle “START” have been checked in step 68, a “NULL” result indicating that the vertex V is not contained in the referencing triangle “START” nor the neighboring triangles thereof is reported to the parent function, which might be the main program of the rubber-sheeting process or the recursive directional flood search function itself, in the step 69. The parent function can then reiterate the direction flood search by setting another referencing triangle until the triangle that contains the vertex V is found. When the vertex V is found at the left side of the edge in step 63, the location of the vertex V relative to a next triangle sharing the same edge of the referencing triangle “START” is determined in step 64. If the next triangle is visited, the process flows to step 67 to skip checking this neighbor. If not, AB is used for recursive call in step 65. If a triangle containing the vertex V is found in step 65, the process flows through step 66 to step 68; otherwise, the process flows to step 67 until all edges of the referencing triangle “START” has been examined. By the directional flood method, the time complexity of point location is linearly to the number of control points. In real application, sub-linear performance can actually be achieved even without a nearby starting triangle.

Once the control points are located by the directional flood method as shown in FIG. 8, the Barycentric coordinate of the vertex V, that is, the screen coordinate of the vertex V as a function of the coordinates of the vertices of the referencing triangle “START” a, b, c can be computed. As the image coordinates of the vertices a, b, c are also available, the image coordinate of the vertex V can also be computed based on the Barycentric coordinate thereof and the image locations of the vertices a, b, c. Once the image coordinates of all the pixels within a triangle are obtained, the user can then get the color value for each pixel by bilinear sampling described in step 26 as shown in FIG. 2.

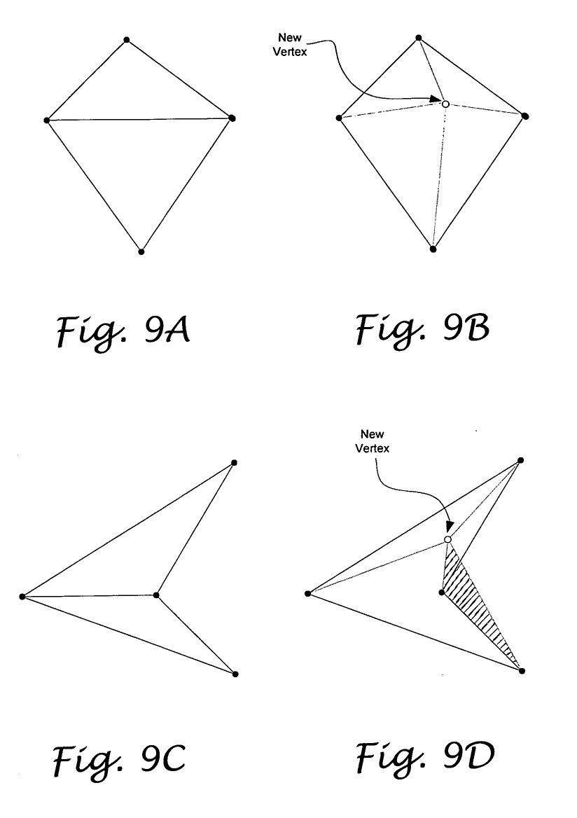

Similar to the process of locating or selecting a control point, the Delaunay triangulation method as provided allows the user to dynamically insert, delete or move a control point. However, interactively adding a new control point for rubber sheeting is tricky because some triangle may form flipped triangle, or a triangle with a negative area as shown in FIGS. 9A to 9D. FIGS. 9A and 9B show triangles with image coordinates, and FIGS. 9C and 9D show the triangles observed in the screen coordinates. In FIGS. 9B and 9D, a control point is added within the triangle as shown in FIGS. 9A and 9C, respectively. As shown, a flipped triangle (shaded) will generate a flipped sub image when used for rubber sheeting and hence should be avoided in the triangulation for all kinds of input. To allow the user to insert control point at all position at any stage without generating flipped triangle, the task of adding a vertex is separated into two steps, including the step to insert the vertex to the Delaunay triangle, and the step to recursively adjust the flipped triangle by adding helping points.

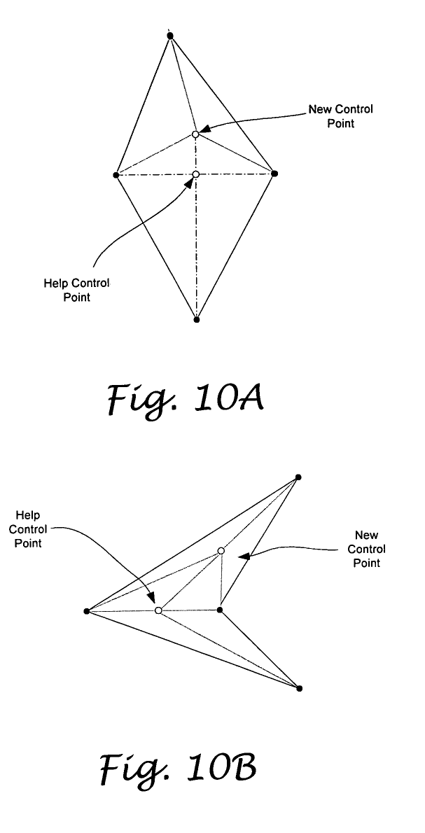

As shown in FIG. 6, when a control point with screen coordinates only is added in step 40, a screen triangle that contains the control point is located in step 41. The image coordinates of the control points are then computed in step 42 by the method as described in FIGS. 5 and 8, and the new control point is built in step 43. The triangulation is then updated in step 44 and followed by recursive visibility adjustment in step 45. The affine transformation for each updated triangle is then updated in step 46. In the process as shown in FIG. 6, basic algorithm such as the edge-flip method is adapted for adding the vertex in the Delaunay triangulation. The edge-flipping operations during an insertion will be marked and checked. If a flipped triangle (negative area) is generated after an edge-flip, the middle point of the edge before flip is saved in a local stack. In the recursive adjust step, each saved middle point will be popped out from the stack and inserted into the triangulation as a helping control point, which in turn may push new helping points into the stack. FIGS. 10A and 10B provide an intuitive explanation of the basic idea of the helping point. As shown, when the control points are added, flipped triangles generated by insertion of the control points are avoided.

When two vertices are connected to each other by an edge having intersections with other triangulation edges, these two vertices are referred as invisible; otherwise, they are visible. It is obvious that any two adjacent triangles sharing an edge in a homomorphic distorted version T′ of a Delaunay triangulation T can have at most one pair of invisible vertices, and the middle points of the visible pairs are visible to all four vertices. After the middle point of the visible pair is added, the invisible pair will never be linked together, while the visible pair will always be linked to the newly inserted middle point. When all the edges have their middle points added, there will be no invisible pair in the triangulation. The recursive adjust procedure will eventually stop when the stack is empty. This ultimately proves the theorem:

“Given a Delaunay triangulation T and its homomorphic distorted version T, by adding middle points of the edges that will be flipped to generate flipped triangles in T′, we can have a new version of T′ that has no flipped triangle.”

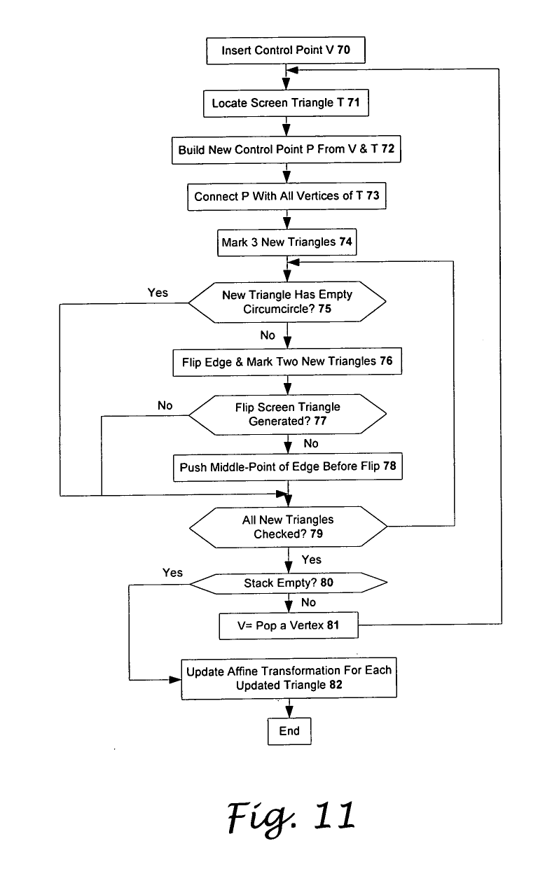

Based on the above approach, the detailed process of inserting a control point or vertex in the Delaunay triangulation can be depicted as shown in FIG. 11. As shown, when a control point V is selected on the screen coordinate in step 70, a triangle T that contains the control point V is located using the flood directional search as shown in FIG. 8 in step 71. Thereby, a new control point P of which the screen coordinate and the image coordinate are available can thus be built from the added control point V and the screen triangle T in step 72. The newly built control point P is then connected to all the vertices of the triangle T in step 73; and consequently, three image triangles can be formed and marked as new in the following step 74. In step 75, whether each of the new image triangles is a Delaunay triangle, that is, whether each of the new image triangles has an empty circum circle, is determined. If the circum circuit of a new image triangle is not empty, the edge that is opposite to P and shared by this new image triangle and a neighboring triangle is flipped, such that new triangle and the neighboring triangle are updated into two new Delaunay image triangles in step 76. The updated Delaunay image triangles obtained by edge flip normally have positive area. However, as the screen coordinates of the vertices may be shifted or displaced from the image-coordinates thereof, the new screen triangles generated by the edge flip process may be flipped, that is, have a negative area. Therefore, when a flipped screen triangle is found to be generated by the edge flip process in step 76, a middle point of the edge is derived to serve as a helping control point in step 78 before performing the edge flip process on the screen coordinate. The middle point, that is, the help control point also have both an image coordinate and a screen coordinate pushed or temporarily saved into a stack. On the other hand, when the circum circle of a new image triangle is found empty in step 75, the new image triangles is checked in step 79. When all the new image triangles and the corresponding screen triangles screen have been checked and, if necessary, updated into Delaunay triangles, whether the stack is empty is determined in step 80. If the stack is found to be empty, it indicates that all the newly generated image triangles are Delaunay and all the screen triangles are positive, and affine transformation for each updated triangle can be updated in step 82. If the stack is not empty, a control point V is popped out from the stack as a helping vertex to be inserted 81, and the process returns back to step 71 to locate the screen triangle that such vertex V belongs again.

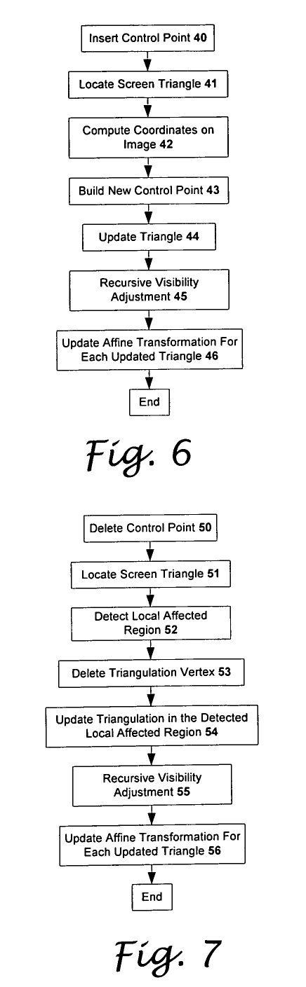

Similar to vertex insertion, deletion of a control point interactively from the triangulation may also generate flipped triangles. A simple example can be reversely constructed from FIGS. 10A-10B to FIGS. 9A-9D. When the user deletes the help control point from FIG. 10B, the resulting triangulation will be the same as shown in FIG. 9D, where a pair of invisible vertices are linked by a triangulation edge. FIG. 7 illustrates the basic function of the deletion of a control point. As shown, when a control point is deleted in step 50, the screen triangle is located in step 51. The local region affected by the deletion is then detected in step 52; and consequently, the triangulation vertex is deleted in step 53. In step 54, the sub-triangulation within the affected region is updated after the deletion of triangulation vertex, followed by recursive visibility adjustment in step 55. The affine transformation for each of the updated triangle is then updated in step 56.

In the process of deleting a control point, some points which are invisible to each other are automatically removed to enable the user to delete any control point without generating flipped triangle. A control point stack is also used here. During updating the triangulation by edge flipping, if the flipped edge connects two invisible vertices, one of them will be pushed into the stack for future deletion. While implementing such process, the choice of point depends on the age field of those two invisible control points. When a control point is added into the triangulation, a unique age is assigned to it and all the vertices inserted after it will have a younger age. It is thus assumed that the control points the user inserted earlier will be more reliable, such that younger point will be pushed back in stack for automation deletion.

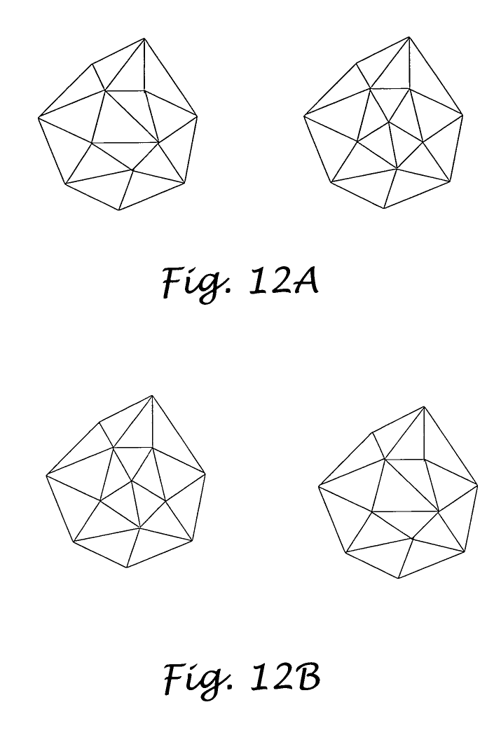

As discussed above, the rubber-sheeting algorithm as provided is to utilize the “local effect” of Delaunay triangulation for high efficiency. When a new vertex is inserted into or removed from a Delaunay triangulation, the effect caused thereby is limited to nearby triangles only. FIGS. 12A and 12B illustrates the local property by adding and removing a control point into and from a triangulation, respectively. When dragging a control point around, only those triangles connected to the point need to be updated, which means the control point movement is only a local operation too. As it can be seen from FIGS. 12A and 12B, all of the updated triangles are always connected to each other and form a connected sub-triangulation. The user only needs to keep track one of the updated triangles to find all the others instead of saving all the updated triangles in an array or stack which consumes more memory and time. In the dynamic Delaunay triangulation as provided, an active triangle pointer which keeps track of one of the updated triangles during an operation is set. The rendered and update procedure can follow the link in the active triangle to recursively process all the connected triangles that need a redraw or an update. Therefore, a high efficiency and smooth, real-time interactive animation for image rubber-sheeting by identifying those local triangles that need update is achieved, while the image-processing cost is limited in the corresponding sub-image is only.

Although the rubber sheeting method as described above is focused on image to image registration and image wrapping, it can also be used to align a vector map with a raster image with a simple modification in the mapping procedure. More specifically, instead of providing an original image composed of a plurality of pixels, a vector map composed of a plurality of vectors and vertices can be provided. For vector-to-raster alignment, vertex-to-pixel mapping is applied in each triangle affine transformation instead of pixel-to-pixel mapping, and the aligned vector map can be generated using all the adjusted vertices.

When all the necessary control points have been specified by the control point locating, inserting and deleting as shown in FIGS. 5-12, the user may select to generate a smoother version of the final result by using a poly-quadric wrapping method in step 28 as shown in FIG. 2. Like many of the piece-wise linear method, the interactive rubber-sheeting algorithm as disclosed here uses Delaunay triangulation can only guarantee a C⁰ continuous result on triangle boundaries. To achieve higher level of smoothness, radial basis functions are usually the best choice. As shown in the following equation, displacement of each image pixel can be obtained from displacements of control points in rubber-sheeting:

$${D}_{i} = {\sum }_{1}^{J} {c}_{j} {S}_{j - i} + {D}_{average}$$

where

cⱼ—coefficients of polyquadrics;

Sⱼ₋ᵢ—distances between unknown and input pixels;

D_{average}—average value of displacement at control points.
The coefficients can be found from solution of linear equations system where each control point/pixel provides two following equation for X and Y displacement as:

$${\sum }_{1}^{K} {c}_{j} {S}_{j - K} + ( {D}_{K} - {D}_{average} ) = 0$$

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A hybrid interactive image registration method, comprising:
1) wrapping an original image by using finite element to find a set of control points and displacement vectors; and
2) smoothing the wrapped image by reversed radial basis function.

2. The method of claim 1, wherein step (1) further comprising:
1a) building dynamic Delaunay triangulation of the original image;
1b) generating affine transformation for each triangle of the triangulation;
1c) getting image-coordinates for each pixel for each triangle; and
1d) getting pixel color value by bilinear sampling.

3. The method of claim 2, further comprising:
1e) adding, deleting or moving a control point.

4. The method of claim 1, wherein step (2) includes a PolyQuadric global wrapping step.

5. The method of claim 1, wherein step (1) includes a free-form interactive shape transformation in three or higher dimension.

6. A dynamic rubber-sheeting using dynamic Delaunay triangulation, comprising:
a) displaying an image;
b) providing at least one of control points;
c) building dynamic Delaunay triangulation of the image based on the control points
d) generating global affine transformation of each triangle of the dynamic Delaunay triangulation when no more than three control points are provided in step (b);
e) generating an affine transformation for each triangle of the dynamic Delaunay triangulation when more than three control points are provided in step (b);
f) rendering an updated sub-image for each of the triangles using affine transformation and bilinear interpolation.

7. The rubber-sheeting of claim 6, wherein step (d) further comprises a step of setting up a translate-only transform when only one control point is provided in step (c).

8. The rubber-sheeting of claim 6, wherein step (d) further comprises a step of setting up a global scale and rotation transform when two control points are provided in step (c).

9. The rubber-sheeting of claim 6, wherein step (d) further comprises computing an global affine transformation when three control points are provided in step (c).

10. The rubber-sheeting of claim 6, further comprising a step of smooth wrapping by reversed radial basis function.

11. The rubber-sheeting of claim 6, wherein step (f) further comprises:
i) computing an image coordinate of each pixel in each triangle; and
ii) obtaining a color value for each pixel.

12. The rubber-sheeting of claim 6, wherein step (b) further comprising:
i) setting a referencing triangle having an image location on the original image and a screen location on a screen coordinate on which the image is to be wrapped;
ii) selecting a pixel/vertex on the screen coordinate;
iii) determining whether the referencing triangle contains the vertex or not;
iv) selecting a new pixel/vertex and repeating steps (ii) and (iii) when the vertex is contained in the reference triangle;
v) marking the referencing triangle as visited when the vertex is not contained in the referencing triangle;
vi) determining a location of the vertex relative to each edge of the referencing triangle;
vii) determining whether a neighboring triangle sharing each edge of the referencing triangle therewith contains the vertex according to the location of the vertex relative to the first edge;
viii) reporting a “null” searching result when none of the neighboring triangles of the referencing triangles contain the vertex; and
ix) finding an image location of the vertex on the image coordinate if the vertex is contained in the referencing triangle or any neighboring triangle thereof.

13. The rubber-sheeting of claim 12, wherein step ix) further comprises:
1) computing a Barycentric coordinate of the vertex using screen locations of vertices of the referencing or neighboring triangle containing the vertex;
2) computing an image location of the of the vertex using image locations of vertices of the referencing or neighboring triangle containing the vertex.

14. The rubber-sheeting of claim 6, further comprising the step of:
g) adding, deleting, and/or moving a control point; and
h) repeating steps (b) to (f) until no more control point to be added, deleted and/or moved.

15. The rubber-sheeting of claim 14, wherein the step (g) further comprises:
i) adding, deleting, and/or moving the control point on a screen coordinate on which the image is to be wrapped;
ii) for adding and deleting, locating a triangle containing the control point on the screen coordinate; and
iii) for adding and deleting, computing an image location of the control point on the original unwrapped image.

16. The rubber-sheeting of claim 15, wherein step (i) further comprising an aging step which automatically removes younger control point to avoid flipped triangle when the control point is deleted.

17. The rubber-sheeting of claim 15, wherein step (iii) further comprises:
1) using image locations of the triangle vertices to compute the image location of the control point;
2) building a new control point using the screen location and the computed image location;
3) inserting the new control point to the triangulation and updating the Delaunay triangulation;
4) performing recursive visibility adjustment to prevent generation of flipped triangle; and
5) updating affine transformation for each updated triangle.

18. The rubber-sheeting of claim 17, wherein step (3) further comprises:
3a) connecting the new control point to all vertices of the triangle, so as to resulting three new image triangles;
3b) determining whether each of the new image triangles has an empty circum circle; and
3c) performing edge-flip for each new image triangle that has a nonempty circum circle.

19. The rubber-sheeting of claim 18, wherein step (3c) further comprising converting the new image triangle and a neighboring triangle sharing an edge with the new image triangle into two new Delaunay triangles.

20. The rubber-sheeting of claim 19, further comprising:
(3d) determining whether the new Delaunay triangles to be on the screen coordinate by performing edge flip process has a negative area on screen or not;
(3e) locating a help control point on the screen coordinate if at least one of the new Delaunay triangles has a negative area; and
(3f) performing the edge flip process on the screen coordinate with reference to the help control point.

21. The rubber-sheeting of claim 20, wherein step (3e) further comprises locating the middle point of the edge that is shared by the new image triangle and the neighboring triangle and connects the two visible vertices on the screen coordinate to serve as the help control point.

22. The rubber-sheeting of claim 21, further comprising a step of pushing the middle point in a stack.

23. The rubber-sheeting of claim 15, wherein step (iii) further comprises:
1) detecting local regions affected by deletion of the control point;
2) deleting the triangulation vertex on the image coordinate represented by the control point to be deleted;
3) updating the Delaunay triangulation;
4) performing recursive visibility adjustment to prevent generation of flipped triangle; and
5) updating affine transformation for each updated triangle.

24. The rubber-sheeting of claim 23, wherein step (4) further comprises automatically removing the more recently inserted control point of any invisible control point pair existing in the affected regions.

25. The rubber-sheeting of claim 14, wherein step (g) further comprises:
i) dragging a control point on a screen coordinate on which the image is to be wrapped;
ii) terminating the process if any of the associated triangles has a negative area on screen;
iii) updating the screen location of the control point if all the associated triangles have positive areas on screen; and
iv) updating affine transformation for all the associated triangles.

26. A directional flood search method, comprising:
a) providing an image with an image coordinate system;
b) setting a referencing triangle on the image coordinate;
c) defining a screen coordinate system on which the image is to be wrapped, and a screen location of each vertex of the referencing triangle;
d) selecting a vertex on the screen coordinate system;
c) determining whether the referencing triangle containing the vertex or not; and
e) determining whether any neighboring triangles of the referencing triangle containing the vertex or not if the referencing vertex does not contain the vertex.

27. The method of claim 26, further comprising a step of:
f) selecting a new vertex to be located when the vertex is contained in the referencing triangle; and
g) iterating steps (a) to (e) for the new vertex.

28. The method of claim 26, wherein when the vertex is contained in either the referencing triangle or any of the neighboring triangles, further comprises the steps of reporting the triangle to the parent function.

29. The method of claim 26, wherein if the vertex is not contained in either the referencing triangle or any neighboring triangles, further comprises the step of reporting a null searching result.

30. A rubber-sheeting method using Delaunay triangulation, comprising:
providing an image on an image coordinate system;
performing Delaunay triangulation on the image to segment the image into a plurality of triangles;
defining a screen coordinate system for the image to be wrapped thereon, such that each vertex of every triangle has both an image location and a screen location;
adding, deleting or moving a control point on the screen coordinate system;
updating the Delaunay triangulation on the image coordinate system;
performing recursive visibility adjustment; and
updating affine transformation for each updated triangle.

31. The method of claim 30, further comprising the steps when a control point is added:
finding the triangle containing the control point;
building a new control point on the image coordinate based on the added control point and the triangle containing the control point;
connecting the new control point with each vertex of the triangle, so as to form three new image triangles;
determining whether each of the new image triangles is a Delaunay triangle; and
performing edge flip on any of the new image triangles which is determined to be an illegal Delaunay triangle.

32. The method of claim 31, further comprising:
determining whether any Delaunay triangle generated by the process of edge flip on the screen coordinate has a negative area, or the flipped edge connects an invisible pair of vertices in screen coordinate system;
setting a middle point on a shared edge between the new image triangle that requires the edge flip process and a neighboring triangle thereof as a help control point before edge flipping.

33. The method of claim 30, further comprising the steps when a control point is deleted:
locating the triangles containing the control point;
detecting a local area/sub-triangulation affected by deletion of the control point;
deleting a vertex on the image coordinate system corresponding to the deleted control point;
updating the Delaunay triangulation;
performing recursive visibility adjustment; and
updating affine transformation for each updated triangle.

34. The method of claim 33, wherein the step of recursive visibility adjustment further comprising automatically removing any invisible control point existing upon deletion of the control point.

35. The method of claim 30, further comprising the steps when a control point is moved:
determining whether all the triangles associated with the control point have positive area; and
refusing the movement requirement of the control point when negative triangle in screen-coordinate system will be generated.

36. The method of claim 30, further comprising the steps when a control point is moved:
determining whether all the triangles associated with the control point have positive area;
updating screen location of the control point if all the associated triangles have positive areas; and
updating affine transformation for all associated triangle

37. A rubber sheeting method, comprising:
providing an original vector map composed of a plurality of vertices and vectors;
providing a target image composed of a plurality of pixels; and
mapping the vertices with the pixels.
